(19) United States
(12) Patent Application Publication
(10) Pub. No.: US 2010/0049904 A1
(43) Pub. Date: Feb. 25, 2010

(54) STORAGE DEVICE USING A MULTI-LEVEL FLASH MEMORY AS A SINGLE FLASH MEMORY AND METHOD FOR THE SAME

(75) Inventor: Ju-peng Chen, Taipei City (TW)

Correspondence Address: KIRTON AND MCCONKIE, 60 EAST SOUTH TEMPLE,, SUITE 1800, SALT LAKE CITY, UT, 84111, US

(73) Assignee: GENESYS LOGIC, INC., Shindian City (TW)

(21) Appl. No.: 12/276,489

(22) Filed: Nov. 24, 2008

(30) Foreign Application Priority Data
Aug. 22, 2008 (TW) 097132295

(51) Int. Cl. G06F 12/02; G06F 12/00

(52) U.S. Cl. 711/103; 711/E12.001; 711/E12.008

(57) ABSTRACT

A storage device includes a multi-level cell flash memory having a plurality of physical memory cells, a read controller, and a write controller. The physical memory cells form a first page and a second page. The write controller in response to a first request is used for writing first data into the first page, duplicating the first data as a second data and writing the second data into the second page. The read controller is used for adjusting the stored data value complying with a desired storing value. Each physical memory cell comprises four threshold voltage ranges indicative of two-bit logical values. The two-bit data is assigned as a first logical value accordingly in response to a two-bit data corresponding to a first and second threshold voltage ranges in a first physical memory cell. The two-bit data is assigned as a second logical value accordingly in response to a two-bit data corresponding to a third and fourth threshold voltage ranges in a second physical memory cell.

### BACKGROUND OF THE INVENTION

1. Field of the Invention

The present invention relates to a storage device using a flash memory and related method, and more particularly, to a storage device using a multi-level flash memory as a single flash memory and method for the same.

2. Description of the Related Art

A flash Memory, a non-volatile memory, may keep the previously stored written data upon shutdown. In contrast to other storage media, e.g. hard disks, soft disks, magnetic tapes and so on, the flash memory has advantages of small volume, light weight, vibration-proof, low power consumption, and no mechanical movement delay in data access, therefore, are widely used as storage media in consumer electronic devices, embedded systems, or portable computers.

There are two kinds of flash memory: an NOR flash memory and an NAND flash memory. An NOR flash memory is characteristically of low driving voltage, fast access speed, high stability, and are widely applied in portable electrical devices and communication devices such as Personal Computers (PCs), mobile phones, personal digital assistances (PDAs), and set-top boxes (STBs). An NAND flash memory is specifically designed as data storage media, for example, a Secure Digital (SD) memory card, a Compact Flash (CF) card, a Memory Stick (MS) card. Charges move across a floating gate relying on charge coupling which determines a threshold voltage of a transistor under the floating gate upon writing, erasing and reading. In other words, in response to an injection of electrons into the floating gate, the logical status of the floating gate turns from 1 to 0; on the contrary, in response to a move of electrons away from the floating gate, the logical status of the floating gate turns from 0 to 1.

The NAND flash memory contains a plurality of blocks, and each block has a plurality of pages wherein each page is divided into data area and spare area. The data area may contain 2048 bytes which are used for storing data. The spare area may contain 64 bytes which are used for storing error correction code (ECC). However, the flash memory may fail to change data update-in-place, in other words, erasing a block including the non-blank page is required prior to writing data into a non-blank page. If a size of written data is over an assigned block, the filled pages in the assigned block may have to be removed to other blocks, and then erasing the assigned block is performed.

There are two kinds of NAND flash memory: a multi-level cell (MLC) NAND flash memory and a single-level cell (SLC) flash memory. A cell of the MLC NAND flash memory includes a floating gate for storing various charge levels indicative of binary values 00, 01, 10, and 11. Therefore, each MLC NAND flash memory cell can store four values at one time. Conversely, the SLC NAND flash memory cell contains thinner oxide film between the floating gate and the source. Voltage is applied onto the floating gate during writing process, thereby the stored charge being driven to flow out through the source. Each SLC NAND flash memory cell may store only one-bit data, as is less than the MLC NAND flash memory cell.

Please refer to FIGS. 1 and 2. FIG. 1 shows a structure of a physical cell of a NAND flash memory. FIG. 2 shows a relationship between a threshold voltage (Vt) and gate charge distribution of a physical cell of a Single-level cell (SLC) flash memory. The physical cell 54 comprises a floating gate 542, a source 544, a drain 546, and a gate 548. Differences of threshold voltage Vt of the physical cell 54 responding to various voltage levels in the gate indicates various logical values. As shown in FIG. 2, for example, if threshold voltage exceeds 4 Volts, it indicates that the logical value of the physical cell 54 is “0”. If threshold voltage is less than 4 Volts, it indicates that the logical value of the physical cell 54 is “1”.

FIG. 3 shows a relationship between a threshold voltage (Vt) and gate charge distribution of a physical cell of a Multi-level cell (MLC) flash memory. In general, a logical value “11” indicates that the threshold voltage of the MLC flash memory 54 is below 3.5 volts. A logical value “10” indicates that the threshold voltage of the MLC flash memory 54 is in a range between 3.5-4 volts; a logical value “01” indicates that the threshold voltage of the MLC flash memory 54 is in a range between 4-5.5 volts; and a logical value “00” indicates that the threshold voltage of the MLC flash memory 54 is over 5.5 volts. Traditionally, the MLC flash memory has a greater memory density and a faster access time than the SLC flash memory. Furthermore, a NAND SLC (single-level cell) flash memory can sustain up to a hundred thousand access times, while NAND MLC flash memory can only sustain ten thousand access times. In other words, the NAND MLC flash memory has a shorter life time than that of SLC flash memory. Additionally, power consumption of the NAND MLC flash memory is more than that of the SLC flash memory by 15%.

However, the price cost of SLC NAND flash memory is higher than that of MLC NAND flash memory. For example, a 2 giga-bytes SLC flash memory is more expensive than that of a 4 giga-bytes MLC flash memory. Therefore, concerning of the higher price, the use of NAND multifunction flash memory is more dominant.

### SUMMARY OF THE INVENTION

It is therefore an object of the present invention to provide a storage device using a multi-level flash memory as a single flash memory to reduce cost of a storage device using a single flash memory.

According to the claimed invention, a storage device comprises a multi-level cell NAND flash memory and a write controller, wherein the multi-level cell NAND flash memory comprises a plurality of physical cells. The plurality of physical cells forms a first page and a second page, and the plurality of physical cells comprises a first physical cell and a second physical cell. The write controller is used for writing first data into the first page, duplicating the first data as a second data and writing the second data into the second page. Each physical memory cell comprises four threshold voltage ranges indicative of two-bit logical values. When a first two-bit data within the first physical memory cell is in a range between a first and second threshold voltage ranges, the first two-bit data is assigned as a first logical value. When a second two-bit data within the second physical memory cell is in a range between a third and fourth threshold voltage ranges, the second two-bit data is assigned as a second logical value.

In another aspect, the claimed invention provides a method of using a multi-level cell NAND flash memory as a single-level cell NAND flash memory. The method comprises the steps of:
(a) the plurality of physical cells comprising a first physical cell and a second physical cell for providing a multi-level cell NAND flash memory comprising a plurality of physical cells, the plurality of physical cells forming a first page and a second page;
(b) writing the first data into the first page, duplicating the first data as a second data and writing the second data into the second page in response to a first request to write first data; and
(c) determining the first data by detecting the first data stored in the first page and the second data stored in the second page in response to a second request to read the first data.

The present invention will be described with reference to the accompanying drawings, which show exemplary embodiments of the present invention.

### BRIEF DESCRIPTION OF THE DRAWINGS

FIG. 1 shows a structure of a physical cell of a NAND flash memory.

FIG. 2 shows a relationship between a threshold voltage (Vt) and gate charge distribution of a physical cell of a Single-level cell (SLC) flash memory.

FIG. 3 shows a relationship between a threshold voltage (Vt) and gate charge distribution of a physical cell of a Multi-level cell (MLC) flash memory.

FIG. 4 shows a block diagram of a storage device 10 and a host 5 according to a preferred embodiment of the present invention.

FIG. 5 is a flowchart of a method of using an MLC NAND flash memory as a single flash memory according to the present invention.

FIG. 6 illustrates data access of pages of the flash memory shown in FIG. 4.

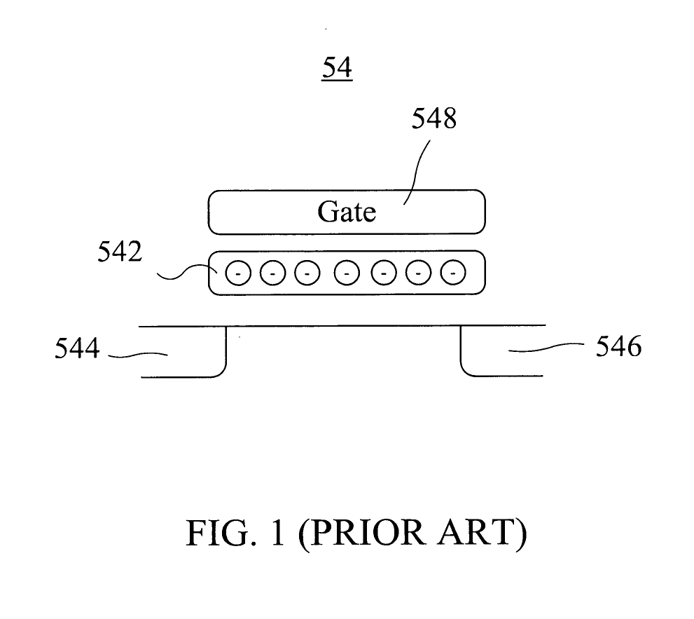

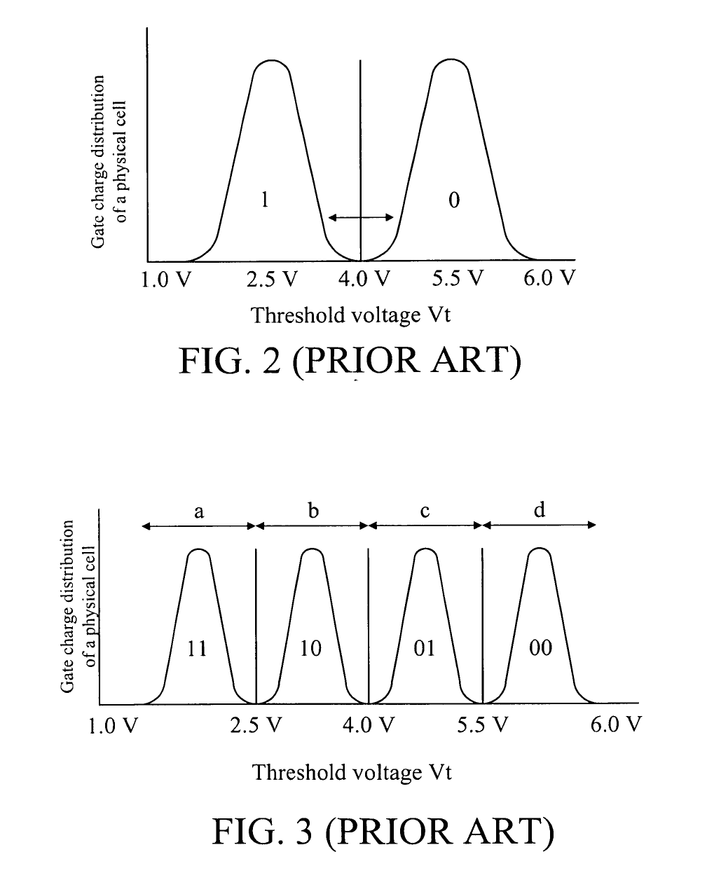

### DETAILED DESCRIPTION OF THE INVENTION

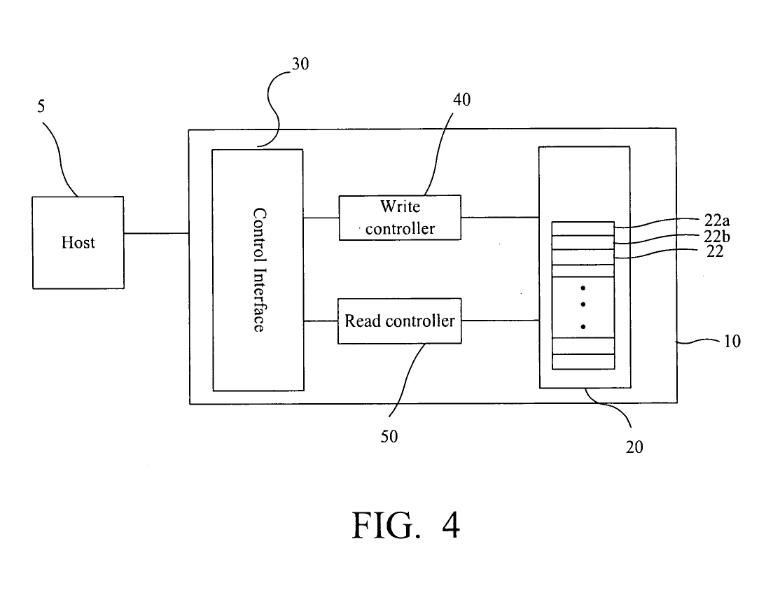

Please refer to FIG. 4, which shows a block diagram of a storage device 10 and a host 5 according to a preferred embodiment of the present invention. The storage device 10 comprises a flash memory 20, a control interface 30, a write controller 40, and a read controller 50. The flash memory 20 is a multi-level cell (MLC) NAND flash memory having a plurality of pages 22 for storing data.

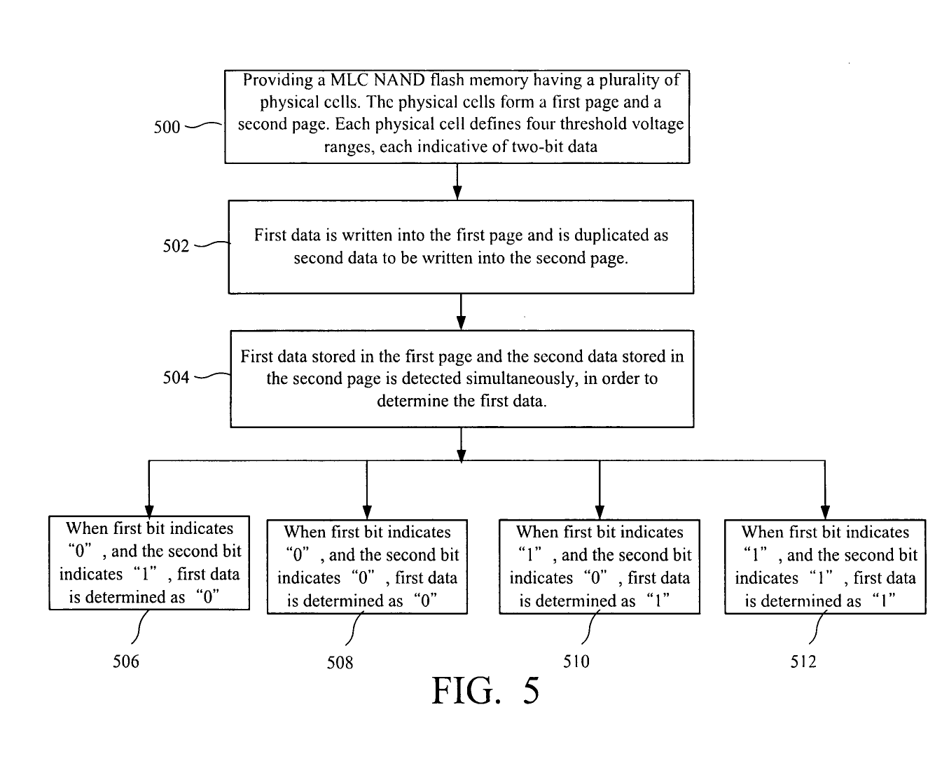

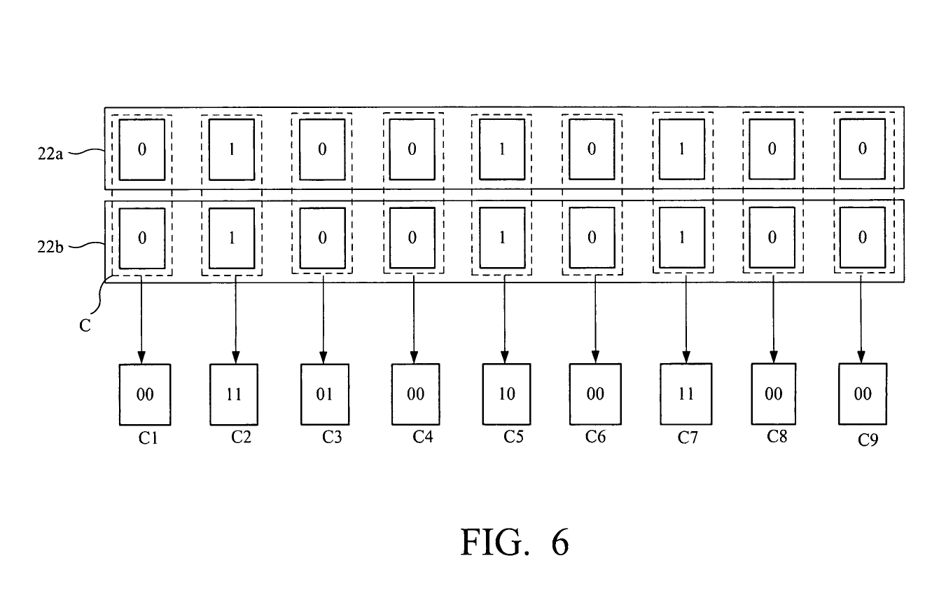

Please refer to FIGS. 4, 5 and 6. FIG. 5 is a flowchart of a method of using an MLC NAND flash memory as a single flash memory according to the present invention. FIG. 6 illustrates data access of pages of the flash memory shown in FIG. 4. The method comprises steps of:
Step 500: Providing an MLC NAND flash memory having a plurality of physical cells. The physical cells form a first page and a second page. Each physical cell defines four threshold voltage ranges, each indicative of two-bit data.
Step 502: upon receiving a first request to write first data into the first page, the first data is written into the first page and is duplicated as second data to be written into the second page. The first data comprises a first bit, and the second data comprises a second bit. The first bit and the second bit belongs to a physical cell.
Step 504: upon receiving a second request to read first data from the first page, the first data stored in the first page and the second data stored in the second page is detected simultaneously, in order to determine the first data.
Step 506: When the first bit of the first data indicates a first logical value, and the second bit of the second data indicates a second logical value, the first data is determined as the first logical value.
Step 508: When the first bit of the first data indicates the first logical value, and the second bit of the second data indicates the first logical value, the first data is determined as the first logical value.
Step 510: When the first bit of the first data indicates the second logical value, and the second bit of the second data indicates the first logical value, the first data is determined as the second logical value.
Step 512: When the first bit of the first data indicates the second logical value, and the second bit of the second data indicates the second logical value, the first data is determined as the second logical value.

The MLC NAND flash memory 20 comprises a first page 22a and a second page 22b (Step 500). The MLC NAND flash memory 20 comprises a plurality of physical cells C which forms the first page 22a and the second page 22a. As the storage device 10 links to the host 5, the control interface 30 may send a write request to write first data into the storage device 10 (Step 502). The write controller 40 can write the first data into an assigned page 22, e.g. first page 22a, in response to the write request. Also, the write controller 40 duplicates the first data into second data, then writes the second data into a second page 22b.

Please refer to FIGS. 3 through 6. As the control interface 30 sends a read request to read the first data from the storage device 10. The read controller 50 can detect the first data stored in the first page 22a, and the second data stored in the second page 22b in response to the read request (Step 504). As shown in FIGS. 3 and 5, it is noted that a first bit DA1 within the first data stored in the first page 22a, and a second bit DB1 within the second data stored in the second page 22b belong to a physical cell C1. Similarly, an n-th bit DAn within the first data stored in the first page 22a, and a n-th bit DBn within the second data stored in the second page 22b belong to a physical cell Cn. For brevity, in this embodiment, n equals 9. The read controller 50 determines a logical value of the data within the physical cell Cn according to threshold voltage of the physical cell Cn. For example, the logical value of the data within the physical cell C1 is determined as “00” in response to the threshold voltage over 5.5 Volts (i.e. voltage range d shown in FIG. 3). The logical value of the data within the physical cell C2 is determined as “11” in response to the threshold voltage less than 2.5 Volts (i.e. voltage range a shown in FIG. 3). Therefore, the read controller 50 determines and outputs logical value “0” and “1” corresponding to physical cells C1 and C2, respectively (Step 508, 512). When a logical value of the data within the physical cell C3 is determined as “01” in response to the threshold voltage in a range between 4.0-5.5 Volts (i.e. voltage range c shown in FIG. 3), the read controller 50 determines the logical value of the data within the physical cell C3 as “01” but outputs the logical value “0” (Step 506). When a logical value of the data within the physical cell C5 is determined as “10” in response to the threshold voltage in a range between 2.5-4.0 Volts (i.e. voltage range b shown in FIG. 3), the read controller 50 determines the logical value of the data within the physical cell C5 as “10” but outputs the logical value “1” (Step 510). In other words, the read controller 50 outputs the logical value “1” even if the physical cell of the MLC NAND flash memory actually stores logical value “11” or “10” (i.e. the threshold voltage is below 4 Volts). Otherwise, the read controller 50 outputs the logical value “0” even if the physical cell of the MLC NAND flash memory actually stores logical value “00” or “01” (i.e. the threshold voltage is over 4 Volts). Accordingly, take FIG. 3 as an example, if the original first data is “010010100”, even if slight threshold voltage offsets of the physical cells C3, C5 happen, the output remains “010010100”.

In sum, the assigned data will not only be written into a first page, but also copied to a second page in response to a write request. Once a read request to read the assigned data is instructed, the data is determined by considering both data stored in the first and second pages. Consequently, the present invention provides a storage device using a multi-level flash memory as a single flash memory to reduce cost of a storage device using a single flash memory.

Although the present invention has been explained by the embodiments shown in the drawings described above, it should be understood to the ordinary skilled person in the art that the invention is not limited to the embodiments, but rather various changes or modifications thereof are possible without departing from the spirit of the invention. Accordingly, the scope of the invention shall be determined only by the appended claims and their equivalents.

What is claimed is:

1. A storage device comprising:
a multi-level cell NAND flash memory comprising a plurality of physical cells, the plurality of physical cells forming a first page and a second page, the plurality of physical cells comprising a first physical cell and a second physical cell; and
a write controller, for writing first data into the first page, duplicating the first data as a second data and writing the second data into the second page, wherein each physical memory cell comprises four threshold voltage ranges indicative of two-bit logical values when a first two-bit data within the first physical memory cell is in a range between a first and second threshold voltage ranges, the first two-bit data is assigned as a first logical value, and when a second two-bit data within the second physical memory cell is in a range between a third and fourth threshold voltage ranges, the second two-bit data is assigned as a second logical value.

2. The flash memory storage device of claim 1, further comprising a read controller for determining the first data by detecting the first data stored in the first page and the second data stored in the second page.

3. The flash memory storage device of claim 2, wherein the first data comprises a first bit, the second data comprises a second bit, the first bit and the second bit belong to one of the plurality of physical cells, the read controller is used for determining the first data as a first logical value if the first bit of the first data indicates a first logical value, and the second bit of the second data indicates a second logical value, or if the first bit of the first data indicates the first logical value, and the second bit of the second data indicates the first logical value, or for determining the first data as the second logical value if the first bit of the first data indicates the second logical value, and the second bit of the second data indicates the first logical value, or if the first bit of the first data indicates the second logical value, and the second bit of the second data indicates the second logical value.

4. The flash memory storage device of claim 3, wherein the first logical value is 0 and the second logical value is 1.

5. A method of using a multi-level cell NAND flash memory as a single-level cell NAND flash memory, comprising:
(a) providing a multi-level cell NAND flash memory comprising a plurality of physical cells, the plurality of physical cells forming a first page and a second page, the plurality of physical cells comprising a first physical cell and a second physical cell; and
(b) writing the first data into the first page, duplicating the first data as a second data and writing the second data into the second page in response to a first request to write first data.

6. The method of claim 5, further comprising:
(c) determining the first data by detecting the first data stored in the first page and the second data stored in the second page in response to a second request to read the first data.

7. The method of claim 6, wherein the first data comprises a first bit, the second data comprises a second bit, the first bit and the second bit belong to one of the plurality of physical cells, and step (c) comprises:
determining the first data as the first logical value when the first bit of the first data indicates a first logical value, and the second bit of the second data indicates a second logical value;
determining the first data as the first logical value when the first bit of the first data indicates the first logical value, and the second bit of the second data indicates the first logical value;
determining the first data as the second logical value when the first bit of the first data indicates the second logical value, and the second bit of the second data indicates the first logical value; and
determining the first data as the second logical value when the first bit of the first data indicates the second logical value, and the second bit of the second data indicates the second logical value.

8. The method of claim 7, wherein the first logical value is 0 and the second logical value is 1.
